(19) United States
(12) Patent Application Publication
(10) Pub. No.: US 2025/0004178 A1
(43) Pub. Date: Jan. 2, 2025

(54) POLARIZING PLATE, OPTICAL EQUIPMENT, AND METHOD FOR MANUFACTURING A POLARIZING PLATE

(71) Applicant: DEXERIALS CORPORATION, Tochigi (JP)

(72) Inventor: Tomu Takeda, Shimotsuke-shi (JP)

(21) Appl. No.: 18/696,318

(22) PCT Filed: Sep. 7, 2022
(86) PCT No.: PCT/JP2022/033491

§ 371 Date: Mar. 27, 2024

(30) Foreign Application Priority Data
Sep. 30, 2021 (JP) 2021-160780

(51) Int. Cl. G02B 1/14; G02B 5/30; G02F 1/1335; G03B 21/20

(52) U.S. Cl. CPC G02B 1/14; G02B 5/3041; G02B 5/3058; G02F 1/133548; G03B 21/2073

(57) ABSTRACT

A polarizing plate having a wire grid structure includes: a transparent substrate; a plurality of projections disposed on the transparent substrate and spaced apart from each other and periodically arranged in a first direction at a pitch shorter than a bandwidth to be used; and a protective layer that covers the projections and the transparent substrate, wherein each of the projections has a first absorption layer, a reflective layer, and a second absorption layer in order from a side close to the transparent substrate, and a width of a first surface of the reflective layer on a side close to the transparent substrate in the first direction is wider than a width of a second surface of the reflective layer opposite to the first surface in the first direction.

### TECHNICAL FIELD

The present invention relates to a polarizing plate, an optical device, and a method for manufacturing a polarizing plate.

This application claims priority based on Japanese Patent Application No. 2021-160780 filed in Japan on Sep. 30, 2021, the contents of which are incorporated herein.

### BACKGROUND ART

The polarizing plate is an optical element that absorbs polarized light in one direction and transmits polarized light in a direction perpendicular to this. In principle, a liquid crystal display device requires a polarizing plate. In particular, in LCD devices that use a light source with a large amount of light, such as a transmissive LCD projector, the polarizing plate is exposed to strong radiation, so it needs to have excellent heat resistance and light resistance. In addition, high extinction ratio and control of reflectance characteristics are required. In order to meet these demands, wire grid type inorganic polarizing plates have been proposed.

A wire-grid polarizer has a structure in which a number of conductor wires extending in one direction are arranged on a substrate at a pitch (tens to hundreds of nm) narrower than the bandwidth of the wavelength of the light to be used. When light enters this polarizing plate, polarized light parallel to the direction of wire extension (TE wave (S wave)) cannot be transmitted, while polarized light perpendicular to the direction of wire extension (TM wave (P wave)) is transmitted as is.

For example, Patent Document 1 discloses a polarizer having sidebars that can assist each other on the side walls of a wire grid polarizer (polarizer). The sidebars improve the durability of the wire grid polarizers. On the other hand, if the durability of a wire grid polarizer with a high aspect ratio is improved only with sidebars, the width of the sidebars will naturally become wider, causing degradation of polarization characteristics such as decreased transmittance and increased reflectance.

Patent Document 2 discloses a polarizing plate in which an overcoat layer is formed from the tip of a wire grid polarizer (polarizing plate) to the side wall. The overcoat layer supports the wire grid polarizer and prevents it from collapsing. However, forming an overcoat layer increases the number of air interfaces, which causes deterioration of polarization characteristics such as a decrease in transmittance and an increase in reflectance.

### CITATION LIST

### Patent Document

### [Patent Document 1]

Japanese translation of PCT publication No. 2016-536651

### [Patent Document 2]

Publication of Japanese translation of translation of PCT publication No. 2019-536074

### SUMMARY OF INVENTION

### Technical Problem

In recent years, lighting and display light sources have evolved from lamps to LEDs and then to lasers. Even in liquid crystal projectors, a high luminous flux is achieved by using a number of semiconductor lasers (LDs), thereby increasing the brightness of the liquid crystal projector. Polarizing plates are required to have durability even under environments with high intensity and strong light.

Coating the wire grid structure with a protective film is one way to increase the durability of the polarizing plate. On the other hand, adding a protective film to a polarizing plate may cause deterioration of optical properties.

The present invention has been made in view of the above problems, and an object of the present invention is to provide a polarizing plate, an optical device, and a method for manufacturing a polarizing plate that has heat resistance and excellent optical properties.

### Solution to Problem

In order to solve the above problems, the present invention proposes the following means.
(1) A polarizing plate having a wire grid structure, the polarizing plate including: a transparent substrate; a plurality of projections disposed on the transparent substrate and spaced apart from each other and periodically arranged in a first direction at a pitch shorter than a bandwidth to be used; and a protective layer that covers the projections and the transparent substrate, wherein each of the projections has a first absorption layer, a reflective layer, and a second absorption layer in order from a side close to the transparent substrate, and a width of a first surface of the reflective layer on a side close to the transparent substrate in the first direction is wider than a width of a second surface of the reflective layer opposite to the first surface in the first direction.
(2) The polarizing plate according to the above aspect may further include a first dielectric layer between the first absorption layer and the reflective layer.
(3) The polarizing plate according to the above aspect may further include a second dielectric layer between the second absorption layer and the reflection layer.
(4) The polarizing plate according to the above aspect may further include a base layer between the transparent substrate and the projections, and the base layer may have a plurality of pedestals that protrude toward the plurality of projections and serve as pedestals for the projections.
(5) In the polarizing plate according to the above aspect, the transparent substrate may be sapphire.
(6) An optical device according to a second aspect includes the polarizing plate according to the above aspect.
(7) The method for manufacturing a polarizing plate according to the third aspect includes the steps of: laminating at least a first absorption layer, a reflective layer and a second absorption layer on a transparent substrate in order; forming a plurality of projections spaced apart from each other and periodically arranged in a first direction at a pitch shorter than a bandwidth to be used by forming a mask on an upper surface of the laminated body laminated and by etching through the mask; and forming a protective layer on the projections formed by etching, wherein the etching is performed under a condition optimized in a preliminary test so that side surfaces of each projections are inclined, or the etching conditions are changed during the etching to form the projections.

### Advantageous Effects of Invention

The polarizing plate and optical device according to this embodiment have heat resistance and excellent optical properties.

### BRIEF EXPLANATION OF DRAWINGS

FIG. 1 is a schematic diagram of an optical device according to the first embodiment.

FIG. 2 is a perspective view of a polarizing plate according to the first embodiment.

FIG. 3 is a cross-sectional view of a polarizing plate according to the first embodiment.

FIG. 4 is a cross-sectional view of a polarizing plate according to the first modified Example.

FIG. 5 is a cross-sectional view of a polarizing plate according to the second modified Example.

FIG. 6 is a cross-sectional view of a polarizing plate according to the third modified Example.

FIG. 7 is a cross-sectional view of a polarizing plate according to Example 3.

FIG. 8 is a cross-sectional view of a polarizing plate according to Example 4.

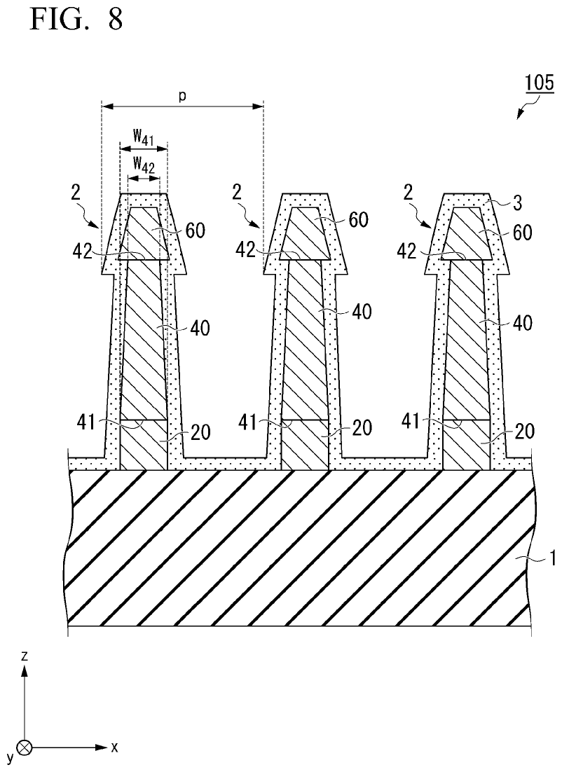

FIG. 9 is a cross-sectional view of a polarizing plate according to Comparative Example 1.

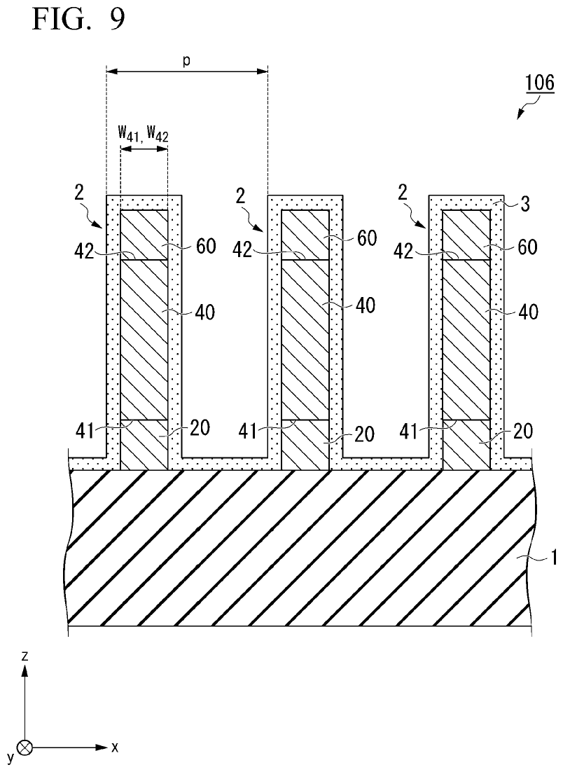

FIG. 10 is a cross-sectional view of a polarizing plate according to Comparative Example 2.

FIG. 11 is a simulation result of optical characteristics of a polarizing plate.

FIG. 12 shows the results of a heat resistance test at 250° C.

FIG. 13 shows the results of a heat resistance test at 300° C.

FIG. 14 shows the results of a heat resistance test at 350° C.

### DESCRIPTIONS OF EMBODIMENTS

The following is a detailed description of this embodiment, referring to the figures as appropriate. In the drawings used in the following description, the characteristic parts may be enlarged for convenience in order to make the features of the invention easier to understand, and the dimensional ratio of each component may be different from the actual one. The materials, dimensions, etc. exemplified in the following description are examples, and the present invention is not limited to them, but can be implemented with appropriate changes to the extent that the effects are achieved.

### [Optical Instrument]

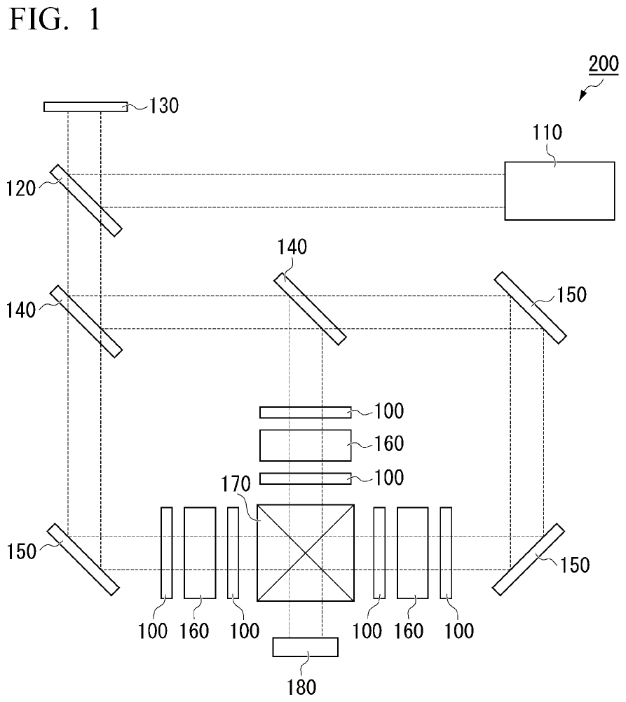

FIG. 1 is a schematic diagram of an optical instrument according to the first embodiment. The optical device shown in FIG. 1 is a transmissive liquid crystal projector 200. Transmissive liquid crystal projector 200 is an example of an optical device. The optical device is not limited to the transmission type liquid crystal projector 200 as long as it includes a polarizing plate. For example, optical devices include liquid crystal displays, head-up displays, and car headlights.

The transmissive liquid crystal projector 200 includes a light source 110, a polarizing beam splitter 120, a phosphor 130, dichroic mirrors 140, mirrors 150, polarizing plates 100, liquid crystal panels 160, and a cross section. It includes a prism 170 and a projection lens 180.

Light source 110 is a laser light source. The light source 110 emits, for example, blue light (wavelength: 380 nm to 490 nm). The S wave of the light emitted from the light source 110 is reflected by the polarizing beam splitter 120 and enters the phosphor 130.

For example, the phosphor 130 absorbs blue light and emits yellow light. The light emitted by the phosphor 130 is combined with the blue light to become white light. The P wave of the white light passes through the polarizing beam splitter 120, is reflected by the dichroic mirrors 140 and mirrors 150, and is separated into blue light, green light, and red light. Each of the blue light, green light, and red light enters a different liquid crystal panel 160.

Polarizing plates 100 are arranged on the incident side and the output side of the liquid crystal panel 160, respectively.

The polarizing plate 100 on the incident side and the polarizing plate 100 on the output side are arranged in a crossed nicol state. When the liquid crystal of the liquid crystal panel 160 is aligned, the light transmitted through the polarizing plate 100 reaches the cross prism 170. The light color-combined by the cross prism 170 is emitted from the projection lens 180.

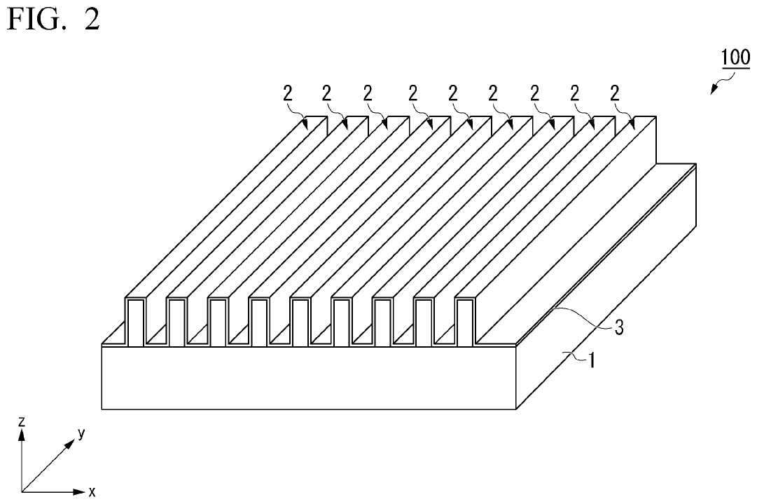

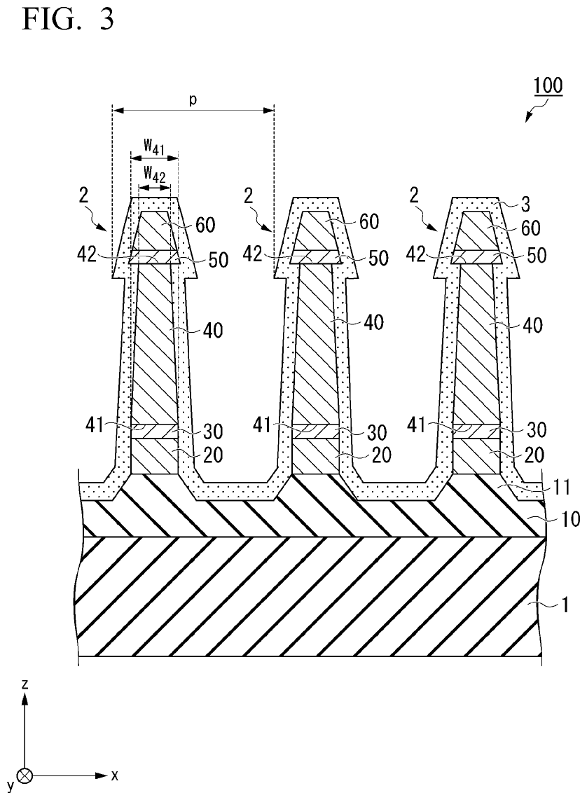

FIG. 2 is a perspective view of the polarizing plate 100 according to the first embodiment. FIG. 3 is a cross-sectional view of the polarizing plate 100 according to the first embodiment. Both the polarizing plate 100 on the incident side and the polarizing plate 100 on the output side of the liquid crystal panel 160 may satisfy the configuration shown below, or only one of them may satisfy the configuration shown below.

The polarizing plate 100 includes a transparent substrate 1, projections 2, and a protective layer 3. Hereinafter, the spreading surface of the transparent substrate 1 is referred to as an xy plane, and the direction orthogonal to the transparent substrate 1 is referred to as a z direction. Further, the direction in which the grid extends is assumed to be the y direction. The direction in which the grid extends is the same as the direction in which each projection 2 extends. Further, the direction perpendicular to the y direction and the z direction is defined as the x direction.

A polarizing plate with a wire grid structure uses four functions: transmission, reflection, interference, and selective optical absorption of polarized waves due to optical anisotropy, to generate polarized waves with an electric field component parallel to the Y-axis direction. (TE waves (S waves)) are attenuated, and polarized waves (TM waves (P waves)) having electric field components parallel to the X-axis direction are transmitted. In FIGS. 2 and 3, the y direction is the direction of the absorption axis of the polarizing plate, and the x direction is the direction of the transmission axis of the polarizing plate.

The transparent substrate 1 exhibits translucency to light in the bandwidth to be used. “Exhibits translucency to light in the bandwidth to be used” does not mean that the transmittance for light in the bandwidth to used is 100%, but that it has a translucent property that can maintain its function as a polarizing plate. Examples of the light in the bandwidth to be used include visible light with a wavelength of 380 nm or more and 810 nm or less. The shape of the main surface of the transparent substrate 1 is not particularly limited, and a shape (for example, a rectangular shape) depending on the purpose is appropriately selected. The average thickness of the transparent substrate 1 is, for example, 0.3 mm or more and 1.0 mm or less.

The refractive index of the transparent substrate 1 is, for example, 1.1 or more and 2.2 or less. The transparent substrate 1 is made of, for example, glass, crystal. quartz, sapphire, or the like. Glass, especially quartz glass (refractive index 1.46) or soda lime glass (refractive index 1.51), is inexpensive and has high transmittance. Crystal or sapphire has excellent thermal conductivity. When crystal or sapphire is used for the transparent substrate 1, the light resistance of the polarizing plate 100 is increased. Crystal or sapphire is suitable for the polarizing plate for the optical engine of the transmission type liquid crystal projector 200, which generates a large amount of heat.

When using an optically active crystal such as quartz or sapphire for the transparent substrate 1, it is preferable that the direction in which the projections 2 extend parallel to or perpendicular to the optical axis of the crystal. This improves the optical properties of the polarizing plate 100. Here, the optical axis is a directional axis where the difference in refractive index between O (ordinary ray) and E (extraordinary ray) of light traveling in that direction is minimum.

Each of the protrusions 2 is on the transparent substrate 1. The projections 2 are spaced apart from each other in the x direction and are periodically arranged at a pitch p shorter than the wavelength of light in the bandwidth to be used. Each of the projections 2 extends in the y direction.

The pitch p of the projections 2 is, for example, 100 nm or more and 200 nm or less. The pitch p is the distance in the x direction between adjacent protrusions 2, and is the sum of the widths in the x direction of the line portion where the protrusions 2 are located and the space portion between the adjacent protrusions 2. The pitch p can be measured using a scanning electron microscope or a transmission electron microscope. For example, the distances between adjacent projections 2 at four arbitrary locations are measured, and the arithmetic average of these distances is set as the pitch p.

The width of the projection 2 in the x direction is, for example, shorter than the wavelength of light in the bandwidth to be used. The width of the projection 2 is, for example, shorter than the pitch p. The average width of the projections 2 in the x direction is, for example, 20% or more and 50% or less of the pitch p. The width of the projection 2 is, for example, 35 nm or more and 45 nm or less. The width of the projection 2 is the width at the center of the height of the projection 2 in the z direction, and can be measured using an electron microscope or the like.

The projection 2 includes, for example, a first absorption layer 20, a first dielectric layer 30, a reflection layer 40, a second dielectric layer 50, and a second absorption layer 60 in this order from the side closest to the transparent substrate 1.

For example, a base layer 10 may be provided between each projection 2 and the transparent substrate 1. The base layer 10 is, for example, silicon oxide. The base layer may have pedestals 11. Each of the pedestals 11 protrudes toward each of the protrusions 2 and serves as a pedestal for each of the protrusions 2.

The width of the base portion 11 in the x direction increases as it approaches the transparent substrate 1. The pedestal portion 11 has a trapezoidal shape in the xz section, for example, an isosceles trapezoid. The pedestal portion 11 can be formed by changing the balance between isotropic etching and anisotropic etching in stages by setting dry etching conditions. When the cross-sectional shape of the pedestal portion 11 is trapezoidal, the refractive index in the z-direction changes stepwise, and light reflection can be prevented.

The first absorption layer 20 extends in a band shape in the y direction, which is the absorption axis. The first absorption layer 20 has an absorption effect on the wavelength of light in the bandwidth to be used. The first absorption layer 20 absorbs, for example, 10% or more of the light incident on the first absorption layer 20, at least in visible light.

The first absorption layer 20 is made of one or more materials selected from the group consisting of metals, alloy materials, and semiconductor materials. The constituent material of the first absorption layer 20 is appropriately selected depending on the wavelength range of the light to which it is applied.

The metallic material used for the first absorption layer 20 is, for example, a single metal such as Ta, Al, Ag, Cu, Au, Mo, Cr, Ti, W, Ni, Fe, Sn, or an alloy containing one or more of these elements. The semiconductor materials used in the first absorption layer 20 are, for example, Si, Ge, Te, ZnO, and silicide materials (β-FeSi₂, MgSi₂, NiSi₂, BaSi₂, CrSi₂, CoSi₂, TaSi, etc.). The first absorption layer 20 should contain Fe or Ta and also Si. It is more preferred that the first absorption layer 20 contains more than 50 wt % Si.

When a semiconductor material is used for the first absorption layer 20, the band gap energy of the semiconductor is involved in the absorption effect. The semiconductor used for the first absorption layer 20 is required to have a bandgap energy equal to or less than the bandwidth to be used. For example, when using visible light, it is necessary to use a material that absorbs at a wavelength of 400 nm or more, that is, has a band gap of 3.1 eV or less.

The thickness of the first absorption layer 20 is, for example, 10 nm or more and 100 nm or less. The thickness of the first absorption layer 20 can be measured using, for example, an electron microscope. The first absorption layer 20 can be formed as a high-density film using, for example, a vapor deposition method or a sputtering method. The first absorbent layer 20 may be composed of two or more layers made of different constituent materials.

A first dielectric layer 30 overlies the first absorption layer 20. The first dielectric layer 30 extends in a band shape in the y direction, which is the absorption axis. The first dielectric layer 30 adjusts the phase of the polarized light incident from the transparent substrate 1 and reflected by the first absorption layer 20 and the polarized light reflected by the reflective layer 40.

The thickness of the first dielectric layer 30 is set, for example, so that the phases of the polarized light reflected by the first absorption layer 20 and the polarized light reflected by the reflective layer 40 are shifted by half a wavelength. The thickness of the first dielectric layer 30 is, for example, 1 nm or more and 500 nm or less. The thickness of the first dielectric layer 30 can be measured using, for example, an electron microscope.

The material constituting the first dielectric layer 30 is, for example, metal oxide, cryolite, germanium, titanium dioxide, silicon, magnesium fluoride (MgF₂), boron nitride, carbon, or a combination thereof. Examples of the metal oxide include silicon oxide, aluminum oxide, beryllium oxide, bismuth oxide, boron oxide, and tantalum oxide. Among these, silicon oxide is preferably used for the first dielectric layer 30.

The refractive index of the first dielectric layer 30 is, for example, 1.0 or more and 2.5 or less. Since the optical properties of the reflective layer 40 are affected by the refractive index of the surroundings, the properties of the polarizing plate 100 can be improved by selecting the material for the first dielectric layer 30. The first dielectric layer 30 is not limited to a single layer, and may be composed of multiple layers made of different constituent materials.

The first absorption layer 20 and the first dielectric layer 30 attenuate light incident on the polarizing plate 100 from the transparent substrate 1 side. Of the light that has passed through the first absorption layer 20 and the first dielectric layer 30, TM waves (P waves) are transmitted through the reflective layer 40, and TE waves (S waves) are reflected by the reflective layer 40. The TE wave reflected by the reflective layer 40 is attenuated by absorption or interference by the first dielectric layer 30 and the first absorption layer 20.

The reflective layer 40 is, for example, on the first dielectric layer 30. The reflective layer 40 extends in a band shape in the y direction, which is the absorption axis.

The reflective layers 40 have a function as a wire grid polarizer. The reflective layers 40 attenuate polarized waves (TE waves (S waves)) having an electric field component in a direction parallel to the longitudinal direction of the reflective layer 40 and attenuate the electric field component in a direction perpendicular to the longitudinal direction of the reflective layer 40. Transmits polarized light waves (TM waves (P waves)). The reflective layer 40 reflects, for example, 10% or more of the light incident on the reflective layer 40, at least in visible light.

The film thickness (thickness in the z direction) of the reflective layer 40 is not particularly limited, and is preferably, for example, 100 nm to 300 nm. Note that the thickness of the reflective layer 40 can be measured using, for example, an electron microscope.

The reflective layer 40 is made of a material that reflects light in the bandwidth to be used. The reflective layer 40 is, for example, a single metal such as Al, Ag, Cu, Mo, Cr, Ti, Ni, W, Fe, Si, Ge, Te, Nd, or an alloy containing one or more of these elements. Aluminum or aluminum alloy can suppress absorption loss in the wire grid to a small level in visible light, and is inexpensive. The reflective layer 40 contains, for example, 50 wt % or more of Al. In addition to these metal materials, the reflective layer 40 may also be an inorganic film or a resin film other than metal, which has a high surface reflectance by, for example, coloring.

The reflective layer 40 can be formed as a high-density film by using, for example, a vapor deposition method or a sputtering method. The reflective layer 40 may be composed of two or more layers made of different constituent materials.

The reflective layer 40 has a first surface 41 and a second surface 42. The first surface 41 is the surface of the reflective layer 40 on the side closer to the first absorption layer 20. The second surface 42 is a surface facing the first surface 41. The first surface 41 and the second surface 42 face each other in the z direction.

The first surface 41 in the x direction is wider than the width W₄₂ of the second surface 42 in the x direction. The width of the reflective layer 40 in the x direction increases, for example, from the second surface 42 toward the first surface 41. For example, the side surface of the reflective layer 40 in the x direction is inclined with respect to the z direction. A metal oxide film may be formed on the side surface of the reflective layer 40.

The second dielectric layer 50 is, for example, on the reflective layer 40. The second dielectric layer 50 extends in a strip shape in the y direction, which is the absorption axis.

The second dielectric layer 50 enters the polarized light from the side opposite to the transparent substrate 1 (grid side) and adjusts the phase of the polarized light reflected by the second absorption layer 60 and the polarized light reflected by the reflective layer 40.

The thickness of the second dielectric layer 50 is set, for example, so that the phases of the polarized light reflected by the second absorption layer 60 and the polarized light reflected by the reflective layer 40 are shifted by half a wavelength. The thickness of the second dielectric layer 50 is, for example, 1 nm or more and 500 nm or less. The thickness of the second dielectric layer 50 can be measured using, for example, an electron microscope.

The second dielectric layer 50 can be made of the same material as the first dielectric layer 30. If the second dielectric layer 50 and the first dielectric layer 30 are made of the same material, the etching conditions during manufacturing can be the same, and the polarizing plate 100 can be manufactured easily. Furthermore, the performances of the first dielectric layer 30 and the second dielectric layer 50 can be matched.

The refractive index of the second dielectric layer 50 is, for example, 1.0 or more and 2.5 or less. Since the optical properties of the reflective layer 40 are affected by the refractive index of the surroundings, the properties of the polarizing plate 100 can be improved by selecting the material for the second dielectric layer 50. The second dielectric layer 50 is not limited to a single layer, but may be composed of multiple layers made of different constituent materials.

The second absorption layer 60 extends in a band shape in the y direction, which is the absorption axis. The second absorption layer 60 has an absorption effect on the wavelength of light in the bandwidth to be used. The second absorption layer 60 absorbs, for example, 10% or more of the light incident on the second absorption layer 60, at least in visible light.

The second absorption layer 60 can be made of the same material as the first absorption layer 20. It is preferable that the second absorbent layer 60 and the first absorbent layer 20 are made of the same material.

The thickness of the second absorption layer 60 is, for example, 10 nm or more and 100 nm or less. The thickness of the second absorption layer 60 can be measured using, for example, an electron microscope. The second absorption layer 60 can be formed as a high-density film using, for example, a vapor deposition method or a sputtering method. The second absorbent layer 60 may be composed of two or more layers made of different constituent materials.

The second dielectric layer 50 and the second absorption layer 60 attenuate light incident on the polarizing plate 100 from the side opposite to the transparent substrate 1 (grid side). Of the light that has passed through the second absorption layer 60 and the second dielectric layer 50, TM waves (P waves) are transmitted through the reflective layer 40, and TE waves (S waves) are reflected by the reflective layer 40. The TE wave reflected by the reflective layer 40 is attenuated by absorption or interference by the second dielectric layer 50 and the second absorption layer 60.

The thickness of the second absorption layer 60 is preferably approximately the same as the thickness of the first absorption layer 20. Further, the thickness of the second dielectric layer 50 is preferably approximately the same as the thickness of the first dielectric layer 30. When the thickness of the first absorption layer 20 is t 1 (nm), the thickness of the second absorption layer 60 is preferably 0.80 t₁ or more and 1.20 t₁ or less, and 0.90 t₁ or more. More preferably, it is 1.10 t₁ or less. When the thickness of the first dielectric layer 30 is t₂ (nm), the thickness of the second dielectric layer 50 is preferably 0.8012 or more and 1.20 t₂ or less. More preferably, it is 0.90 t₂ or more 1.10 t₂ or less.

For example, the side surfaces of the second dielectric layer 50 and the second absorption layer 60 in the x direction are inclined with respect to the z direction. The surface (upper surface) of the second dielectric layer 50 on the reflective layer 40 side is wider in the x direction than the surface (lower surface) of the second absorption layer 60 on the side farther from the reflective layer 40. The width in the x direction of the second dielectric layer 50 and the second absorption layer 60 is, for example, from the surface (top surface) of the second absorption layer 60 far from the reflection layer 40 to the reflection layer 40 side of the second dielectric layer 50. The closer you get to the surface (lower surface), the wider it becomes.

The width of the lower surface of the second dielectric layer 50 in the x direction is, for example, wider than the width W₄₂ of the second surface 42 of the reflective layer in the x direction. For example, there is a step difference between the second dielectric layer 50 and the reflective layer 40.

The protective layer 3 covers the transparent substrate 1 and the projections 2. The protective layer 3 covers, for example, the upper surface of the base layer 10 and the periphery of the projection 2.

The protective layer 3 is, for example, a metal oxide or a metal nitride. The protective layer 3 is, for example, aluminum oxide. The protective layer 3 may have a two-layer structure of aluminum oxide and silicon oxide, for example. By making the outermost surface of the protective layer 3 silicon oxide, the adhesion between the protective layer 3 and the water-repellent layer is improved. The protective layer 3 can be produced by, for example, an ALD (atomic layer deposition) method or a CVD (chemical vapor deposition) method. Further, the protective layer 3 may fill in spaces between the projections 2.

The thickness of the protective layer 3 is, for example, 1 nm or more and 50 nm or less. The thickness of the protective layer 3 is preferably 25 nm or less, more preferably 10 nm or less.

The upper surface of the protective layer 3 may be coated with a water-repellent film. The water-repellent film is, for example, a fluorine-based silane compound. For example, tridecafluorooctyltrichlorosilane (FOTS) is an example of a water-repellent film. The water-repellent film can be produced by an ALI) method, a CVD method, or the like. The water-repellent film improves the moisture resistance of the polarizing plate 100.

The polarizing plate 100 may further include an antireflection layer on the transparent substrate 1 side. The antireflection layer may have, for example, a moth-eye structure, an anti-glare structure, or an anti-reflector structure. The antireflection layer may be, for example, one in which high refractive index layers and low refractive index layers are alternately laminated. The outer surface of the antireflection layer is coated with a protective layer 3, for example.

A polarizing plate can be produced by sequentially performing a laminating process of a laminate, a processing process of a laminate, and a process of coating with a protective layer. Hereinafter, a method for manufacturing a polarizing plate will be described using the polarizing plate 100 shown in FIG. 1 as an example.

First, a base layer 10, a first absorption layer 20, a first dielectric layer 30, a reflective layer 40, a second dielectric layer 50, and a second absorption layer 60 are sequentially formed on a transparent substrate 1 to form a laminate. Each layer can be formed by sputtering, vapor deposition, or the like.

Next, the laminate is processed. The laminate can be produced by a photolithography method, a nanoimprint method, or the like. For example, a grid-like resist mask is formed on the upper surface of the laminate, and selective etching is performed through the mask. Etching is performed, for example, by dry etching. At this time, by optimizing the etching conditions such as the ratio of two or more gases, gas flow rate, gas pressure, power, cooling temperature of the substrate, etc., or by switching the conditions during formation, the side surface of the processing area to be etched can be tilted with respect to the laminating direction. The side surface of the processing area to be etched corresponds to the side surface of the projection 2 after fabrication. The etching conditions are optimized by performing a preliminary test in which a laminate produced under the same conditions is processed while changing the etching conditions. The etching conditions to be changed are, for example, gas ratio from a high etching reactivity ratio to a low etching reactivity ratio, gas flow rate from low flow rate to high flow rate, gas pressure from high pressure to low pressure, power goes from low power to high power, board cooling temperature goes from high temperature to low temperature, and the like. By using one or more of these conditions and switching the conditions during formation, it is possible to form a desired shape.

For example, a mask film is formed on the laminate. The mask film is selectively etched using a resist mask. Then, the laminated body is selectively etched using the mask film remaining after selective etching. The mask film may be composed of two or more layers made of different constituent materials.

Next, a protective layer 3 is formed to cover the projections 2 obtained by processing the laminate. As described above, the protective layer 3 can be formed by, for example, the ALD method, the CVD method, or the like.

The polarizing plate 100 according to the first embodiment has excellent heat resistance. For example, the polarizing plate 100 used in a transmission-type liquid crystal projector 200 or the like is irradiated with laser light, so it easily generates heat. When the polarizing plate 100 generates heat, the reflective layer 40 and the like are thermally oxidized, and the optical characteristics of the polarizing plate 100 deteriorate. In addition, when the polarizing plate 100 has the first absorption layer 20 and the second absorption layer 60 and absorbs light from both the transparent substrate 1 side and the side opposite to the transparent substrate 1 (grid side), the polarizing plate 100 is particularly easily generates heat.

In the polarizing plate 100 according to the first embodiment, the projections 2 are covered with the protective layer 3, and even when the polarizing plate 100 generates heat, thermal oxidation of the reflective layer 40 and the like can be prevented. Furthermore, if the transparent substrate 1 is made of sapphire, which has excellent heat dissipation properties, the amount of heat generated by the polarizing plate 100 can be reduced.

On the other hand, the protective layer 3 is a cause of adding a reflective interface, and simply adding the protective layer 3 lowers the transmittance of the polarizing plate, making it impossible to obtain sufficient optical properties. In contrast, in the polarizing plate 100 according to the first embodiment, the width W₄₁ of the first surface 41 of the reflective layer 40 is wider than the width W₄₂ of the second surface 42, and even when it has the protective layer 3, high transmittance can be achieved.

In addition, the polarizing plate 100 according to the first embodiment includes the first dielectric layer 30 and the second dielectric layer 50, thereby achieving higher transmittance even when the polarizing plate 100 includes the protective layer 3. Further, when the polarizing plate 100 has the first dielectric layer 30 and the second dielectric layer 50, the thickness of the first absorption layer 20 and the second absorption layer 60 can be reduced, and the heat generation of the polarizing plate 100 can be reduced.

Although the embodiment of the present invention has been described above, this embodiment is presented as an example and is not intended to limit the scope of the invention. This embodiment can be implemented in various other forms, and various omissions, substitutions, and changes can be made without departing from the gist of the invention. These embodiments and their modifications are included within the scope and gist of the invention as well as within the scope of the invention described in the claims and its equivalents.

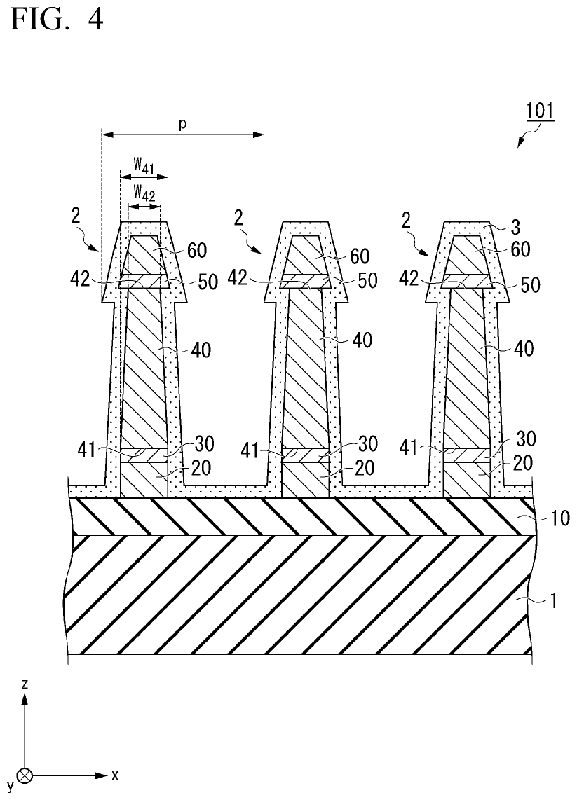

For example, FIG. 4 is a cross-sectional view of the polarizing plate 101 of the first modified Example. FIG. 4 is an xz cross section of the polarizing plate 101. Polarizing plate 101 differs from polarizing plate 100 in that base layer 10 does not have pedestal portion 11. In the polarizing plate 101, the same components as those in the polarizing plate 100 are denoted by the same reference numerals, and the description thereof will be omitted.

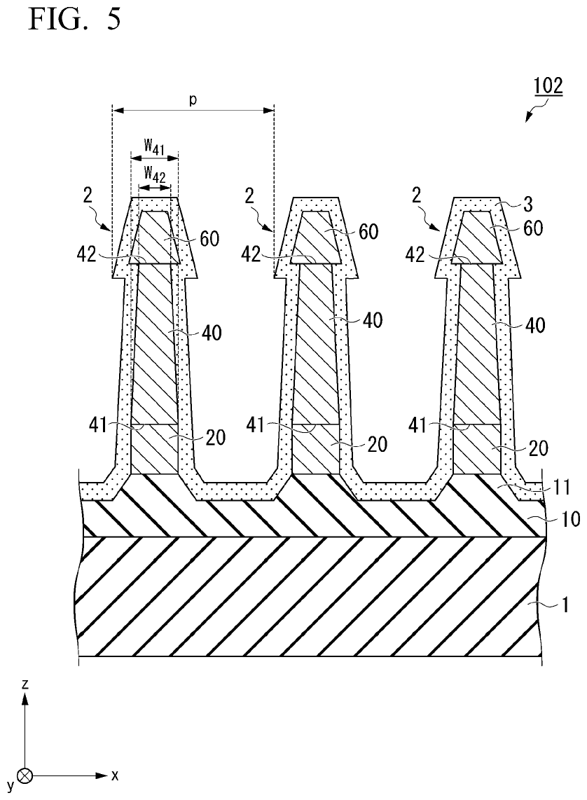

For example. FIG. 5 is a cross-sectional view of the polarizing plate 102 of the second modification. FIG. 5 is an xz cross section of the polarizing plate 102. Polarizing plate 102 differs from polarizing plate 100 in that it does not have first dielectric layer 30 and second dielectric layer 50. In the polarizing plate 102, the same components as those in the polarizing plate 100 are denoted by the same reference numerals, and the description thereof will be omitted.

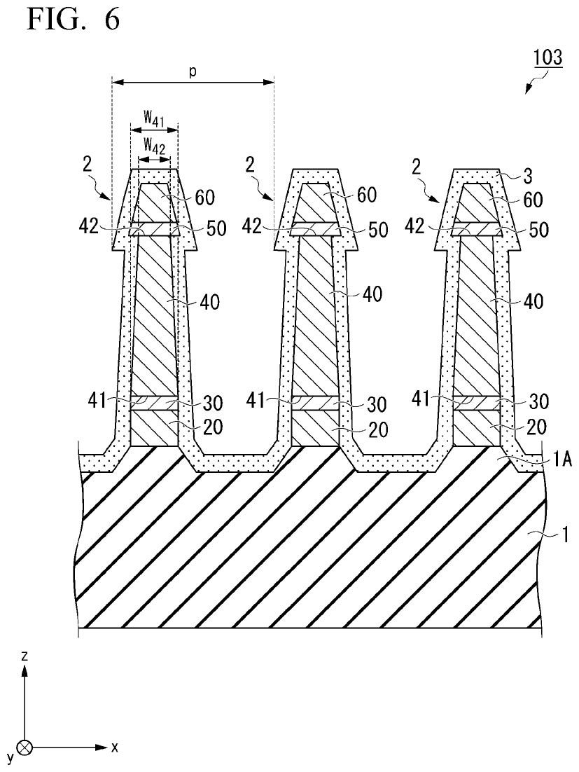

For example, FIG. 6 is a cross-sectional view of the polarizing plate 103 of the third modification. FIG. 6 is an xz cross section of the polarizing plate 103. Polarizing plate 103 differs from polarizing plate 100 in that it does not have a base layer and transparent substrate 1 has pedestal portion 1A. In the polarizing plate 103, the same components as those in the polarizing plate 100 are denoted by the same reference numerals, and the description thereof will be omitted.

### EXAMPLES

### <Optical Characteristics Test>

### Example 1

In Example 1, the structure was similar to that of the polarizing plate 100 shown in FIGS. 2 and 3, and the optical characteristics were measured by simulation. The optical measurement was performed by electromagnetic field simulation using the RC WA (Rigorous Coupled Wave Analysis) method. For the simulation, a grating simulator Gsolver from Grating Solver Development was used.

The composition of each layer was as follows.
Transparent substrate 1: Sapphire
Projection 2: pitch 141 nm, width 35 nm, height 345 nm (including pedestal portion 11)
Base layer 10: thickness 85 nm, SiO₂
Pedestal portion 11: thickness 20 nm, SiO₂
First absorption layer 20: thickness 30 nm, FeSi
First dielectric layer 30: thickness 5 nm, SiO₂
Reflective layer 40: thickness 250 nm, Al, tilt angle of side surface to xy plane 89°
Second dielectric layer 50: thickness 5 nm, SiO₂, tilt angle of side surface to xy plane 80°
Second absorption layer 60: thickness 30 nm, FeSi, tilt angle of side surface to xy plane 80°
Protective layer 3: thickness 5 nm

### Example 2

Example 2 had a structure similar to that shown in the polarizing plate 102 shown in FIG. 5. Example 2 does not have the first dielectric layer 30 and the second dielectric layer 50, and the thicknesses of the first absorption layer 20 and the second absorption layer 60 are different from Example 1.

The structure of each layer in Example 2 is as follows.
Transparent substrate 1: Sapphire
Projection 2: pitch 141 nm, width 35 nm, height 345 nm (including pedestal portion 11)
Base layer 10: thickness 85 nm, SiO₂
Pedestal portion 11: thickness 20 nm. SiO₂
First absorption layer 20: thickness 35 nm. FeSi
Reflective layer 40: thickness 250 nm, Al, tilt angle of side surface to xy plane 89°
Second absorption layer 60: thickness 35 nm, FeSi, tilt angle of side surface to xy plane 80°
Protective layer 3: thickness 5 nm

### Example 3

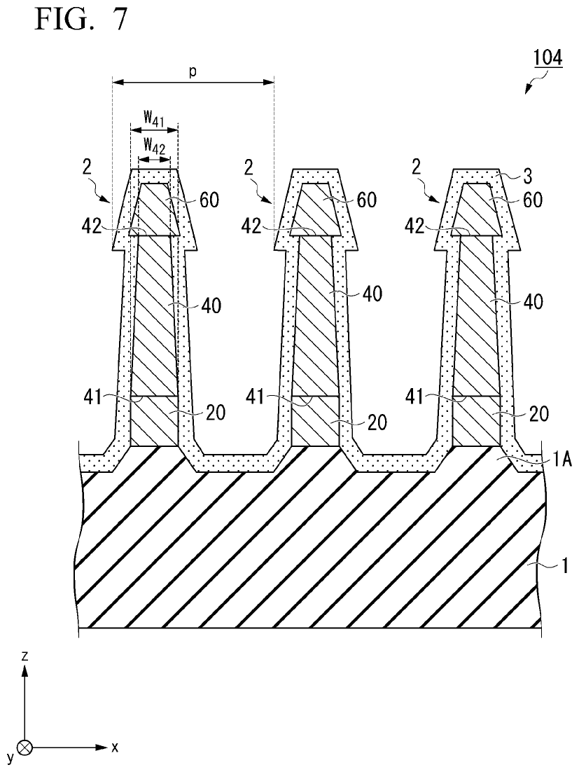

Example 3 had a structure similar to the structure shown in the polarizing plate 104 shown in FIG. 7. Example 3 differs from Example 2 in that the base layer 10 is not provided and the transparent substrate 1 has a pedestal portion 1A.

The configuration of each layer in Example 3 was as follows.
Transparent substrate 1: Sapphire
Pedestal portion 1A: Thickness 20 nm, Sapphire
Projection 2: Pitch 141 nm, width 35 nm, height 345 nm (including pedestal portion 11)
First absorption layer 20: thickness 35 nm, FeSi
Reflective layer 40: thickness 250 nm, Al, tilt angle of side surface to xy plane 89°
Second absorption layer 60: thickness 35 nm, FeSi, tilt angle of side surface to xy plane 80°
Protective layer 3: thickness 5 nm

### Example 4

Example 4 had a structure similar to that shown in the polarizing plate 105 shown in FIG. The fourth embodiment differs from the third embodiment in that it does not include the pedestal portion 1A.

The configuration of each layer in Example 4 was as follows.
Transparent substrate 1: Sapphire
Projection 2: pitch 141 nm, width 35 nm, height 325 nm
First absorption layer 20: thickness 35 nm, FeSi
Reflective layer 40: thickness 250 nm, Al, tilt angle of side surface to xy plane 89°
Second absorption layer 60: thickness 35 nm, FeSi, tilt angle of side surface to xy plane 80°
Protective layer 3: thickness 5 nm

### Comparative Example 1

Comparative Example 1 had a structure similar to that shown in the polarizing plate 106 shown in FIG. Comparative Example 1 differs from Example 4 in that the side surfaces of the reflective layer 40 and the second absorption layer 60 are not sloped.

The configuration of each layer in Comparative Example 1 was as follows.
Transparent substrate 1: Sapphire
Projection 2: Pitch 141 nm, width 35 nm, height 325 nm
First absorption layer 20: thickness 35 nm, FeSi
Reflective layer 40: thickness 250 nm, Al
Second absorption layer 60: thickness 35 nm, FeSi
Protective layer 3: thickness: 5 nm

### Comparative Example 2

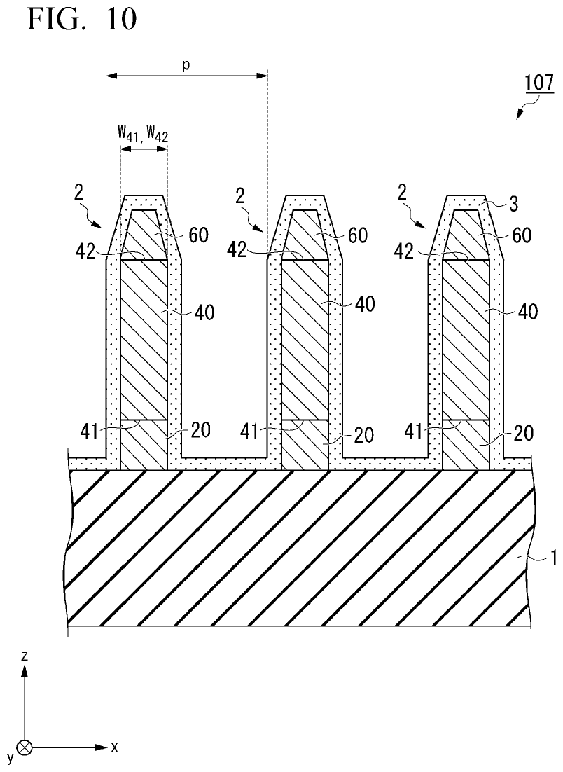

Comparative Example 2 had a structure similar to that of the polarizing plate 107 shown in FIG. 10. Comparative Example 2 differs from Comparative Example 1 in that the side surface of the second absorption layer 60 is sloped.

The composition of each layer of Comparative Example 2 was as follows.
Transparent substrate 1: Sapphire
Projection 2: Pitch 141 nm, width 35 nm, height 325 nm
First absorption layer 20: thickness 35 nm, FeSi
Reflective layer 40: thickness 250 nm, Al
Second absorption layer 60: thickness 35 nm, FeSi, tilt angle of side surface to xy plane 80°
Protective layer 3: thickness: 5 nm

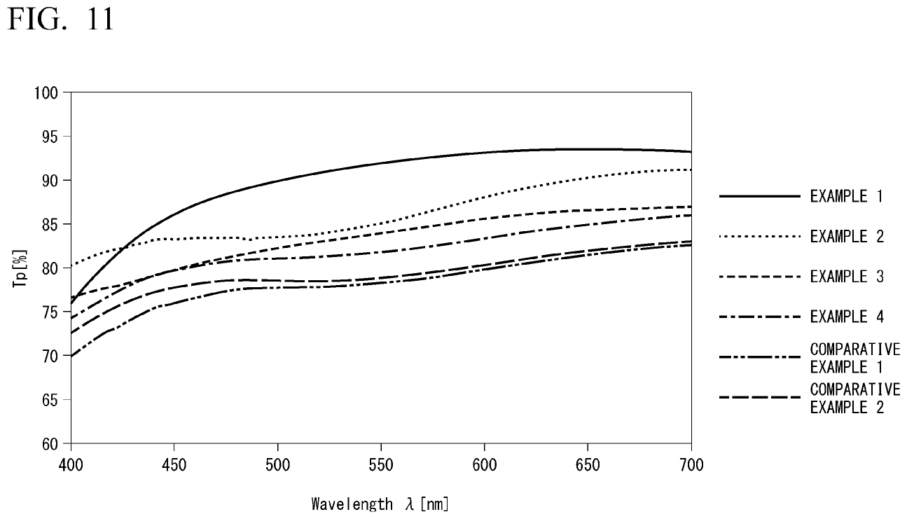

FIG. 11 shows the simulation results of the optical characteristics of the polarizing plates of Examples 1 to 4 and Comparative Examples 1 and 2. The vertical axis in FIG. 11 is transmittance, and the horizontal axis is wavelength.

### <Heat Resistance Test>

A heat resistance test was conducted on the polarizing plates of Example 1, Example 5, and Comparative Example 3. Example 5 and Comparative Example 3 have the following configurations. The heat resistance test was conducted at 250° C., 300° C., and 350° C. The polarizing plate was placed in a constant temperature bath, and the contrast change rate of the polarizing plate after a predetermined period of time was determined. The contrast was determined by dividing the transmittance of TM wave. (P waves) by the transmittance of (TE waves (S waves)). The contrast change rate is the change rate with respect to the contrast of the sample before the heat resistance test.

### Example 5

Example 5 differs from Example 1 in that the thickness of the protective layer 3 is 10 nm.

### Comparative Example 3

Example 3 differs from Example 1 in that it does not have the protective layer 3.

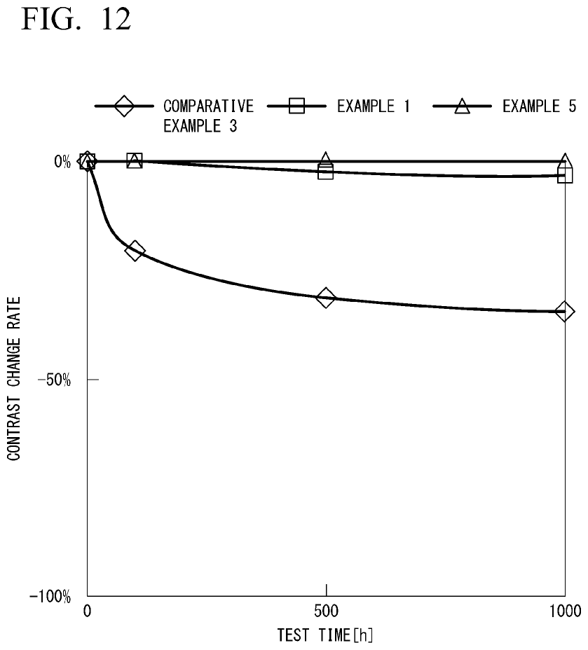

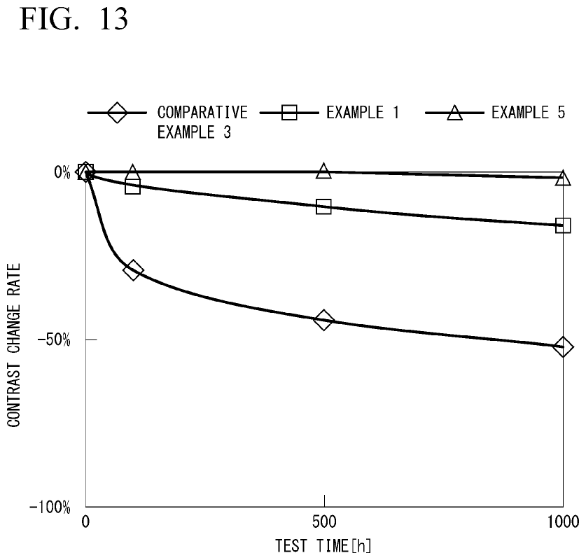

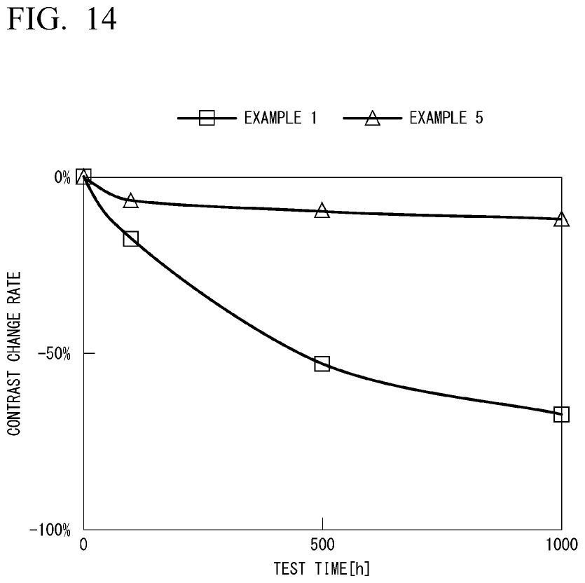

FIG. 12 shows the results of a heat resistance test at 250° C. FIG. 13 shows the results of a heat resistance test at 300° C. FIG. 14 shows the results of a heat resistance test at 350° C.

As shown in FIGS. 12 to 14, heat resistance was improved because the polarizing plate had a protective layer.

### REFERENCE SIGNS LIST

1: Transparent substrate, 1A, 11: Pedestal part, 2: Projection, 3: Protective layer, 10: Under layer, 20: First absorption layer, 30: First dielectric layer, 40: Reflective layer, 41: First surface, 42: Second surface, 50: Second dielectric layer, 60: Second absorption layer, 100, 101, 102, 103, 104, 105, 106, 107: Polarizing plate, 110: Light source, 120: Polarized light beam splitter, 130: Phosphor, 140: Dichroic mirror, 150: Mirror, 160: Liquid crystal panel, 170: Cross prism, 180: Projection lens, 200: Transmissive liquid crystal projector, W₄₁, W₄₂: Width

1. A polarizing plate having a wire grid structure, the polarizing plate comprising:
a transparent substrate;
a plurality of projections disposed on the transparent substrate and spaced apart from each other and periodically arranged in a first direction at a pitch shorter than a bandwidth to be used; and
a protective layer that covers the projections and the transparent substrate, wherein
each of the projections has a first absorption layer, a reflective layer, and a second absorption layer in order from a side close to the transparent substrate, and
a width of a first surface of the reflective layer on a side close to the transparent substrate in the first direction is wider than a width of a second surface of the reflective layer opposite to the first surface in the first direction.

2. The polarizing plate according to claim 1, further comprising a first dielectric layer between the first absorption layer and the reflective layer.

3. The polarizing plate according to claim 1, further comprising a second dielectric layer between the second absorption layer and the reflection layer.

4. The polarizing plate according to claim 1, further comprising a base layer between the transparent substrate and the projections, and
the base layer has a plurality of pedestals that protrude toward the plurality of projections and serve as pedestals for the projections.

5. The polarizing plate according to claim 1, wherein the transparent substrate is sapphire.

6. An optical device comprising the polarizing plate according to claim 1.

7. A method for manufacturing a polarizing plate, the method comprising the steps of:
laminating at least a first absorption layer, a reflective layer and a second absorption layer on a transparent substrate in order,
forming a plurality of projections spaced apart from each other and periodically arranged in a first direction at a pitch shorter than a bandwidth to be used by forming a mask on an upper surface of the laminated body laminated and by etching through the mask, and
forming a protective layer on the projections formed by etching, wherein
the etching is performed under a condition optimized in a preliminary test so that side surfaces of each projections are inclined, or the etching conditions are changed during the etching to form the projections.
